(19) United States
(12) Patent Application Publication
(10) Pub. No.: US 2023/0360564 A1
(43) Pub. Date: Nov. 9, 2023

(54) Flag Classic: The American Spirit

(71) Applicant: Abolaji Bukola Abolariu, Palos Hills, IL (US)

(72) Inventor: Abolaji Bukola Abolariu, Palos Hills, IL (US)

(21) Appl. No.: 17/803,314

(22) Filed: May 9, 2022

(51) Int. Cl. G09F 7/00

(52) U.S. Cl. CPC G09F 7/00

(57) ABSTRACT

Flag classic the American spirit explore ways to promote America's value using words attached to the American flag as a tool in this regard with the believe that greater sense of patriotism and belonging can be instilled in Americans through the instrument of words. Positive thought and words are knows to drive vision and creative possibilities, this is what flag classic is intended to do toward America of our dreams.

### BACKGROUND OF THE INVENTION

Flag is the symbol of every nation. When a flag states the nation's vision, it speaks a lot about the nation. On the other hand, a flag hit the spirit of the people and realize the dream of a nation when it inspire the people to go the extra mile in achieving the country of their dreams.

Flag classic: The American Spirit is invented to instill greater sense of patriotism among Americans toward America of our dreams. Flag classic stand for patriotism, Hope and Opportunities toward a greater America

### DESCRIPTION OF THE DRAWINGS

FIG. 3 is the head of Flag Classic

FIG. 4. is the front leg of Flag Classic

FIG. 5. is the back view of Flag Classic

FIG. 6. is the full assembly of Flag Classic: Front View

FIG. 7. is the full assembly of Flag Classic: Back View

FIG. 1. is the front view of Flag Classic: Wall Flag

FIG. 2. is the back view of Flag Classic: Wall Flag

### DETAILED DESCRIPTION OF THE PARTS

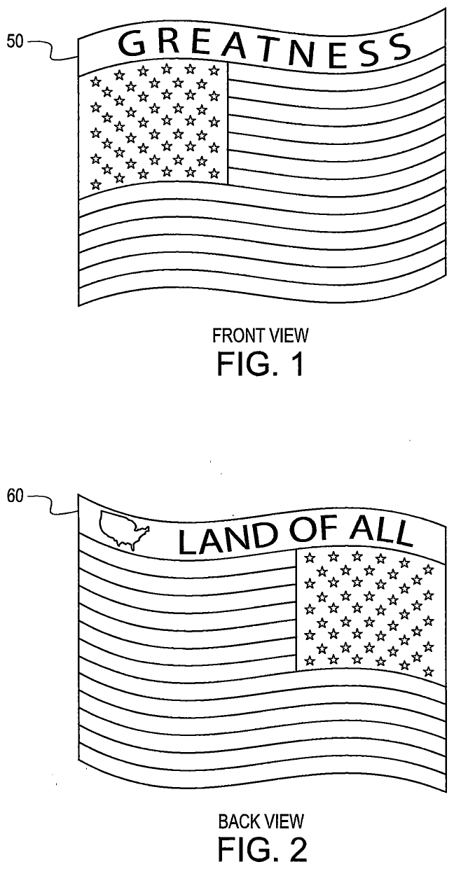

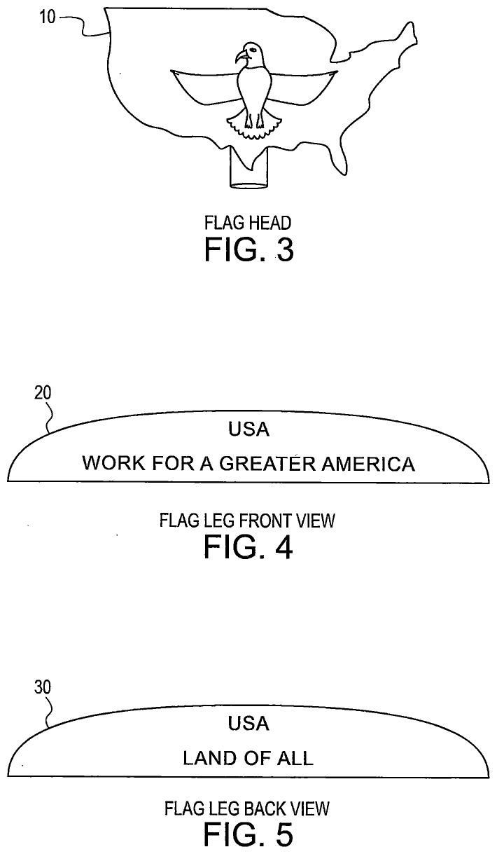

Portion 10. in FIG. 3 is American map created with thick plastic material. Bald Eagle is embossed on it. A hole is created under it to insert American flag.

Portion 20 in FIG. 4 is the front view of a created flag leg made with a thick plastic material to insert American flag. USA logo is embossed in the front. Motivational words ‘WORK FOR A GREATER AMERICA is written on the leg. This is serves as a motivation to instill greater sense of patriotism in Americans. ‘BETTER, SAFER’ are used as new versions are made.

Portion 30 FIG. 3 is the back view of the leg. USA logo is embossed on it and ‘LAND OF ALL’ is always written on it. It symbolize America value as ‘HOME TO ALL’

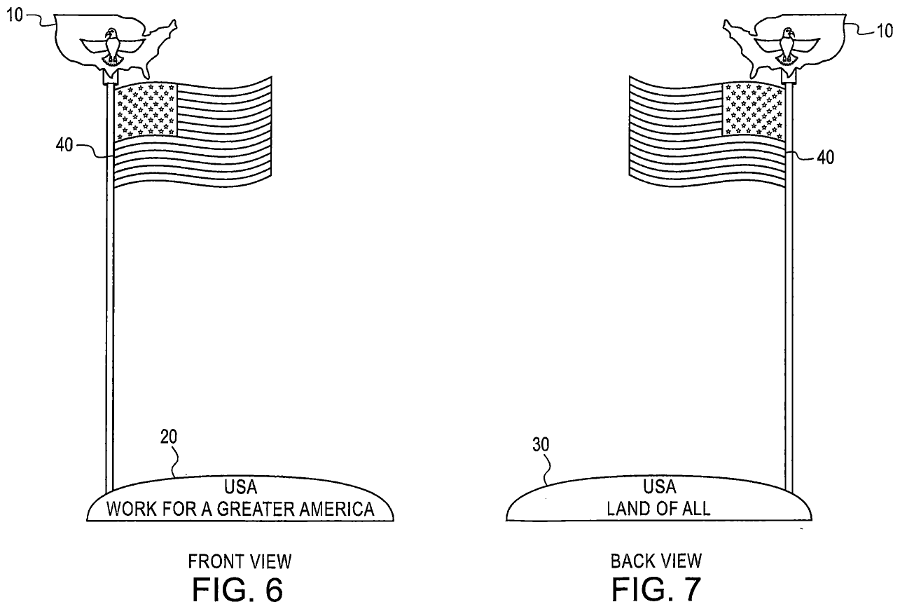

FIG. 6 is the full assembly of Flag Classic: The American Spirit. The flag head is attached to the American Flag on the top and the leg is attached at the lower end.

FIG. 7 is the back view of the full assembly of flag classic with the head attached to the flag at the top and the lower end of the flag attached to the leg.

Portion 50 of FIG. 1 is the front view of the flag classic: WALL FLAG. White fibre sheet is attached to the top of the American Flag and red markings are use to write ‘GREATNESS’ on it. HOPE, POSSIBILITIES, DREAMS are use as different versions of the flag are made.

Portion 60 FIG. 2 is the back view of the Flag Classic: WALL FLAG. American Map is created on the white fibre sheet attached to the flag top: LAND OF ALL’ is written with red marking on it

1. Created American flag head made as American map with thick plastic material. Bald eagle embossed on the map and an opening below to insert American Flag.

2. FIG. 4 and FIG. 5. A created thick plastic leg to insert American Flag with ‘WORK FOR A GREATER AMERICA written on it in the front. USA logo is embossed in the front and back and ‘LAND OF ALL’ written in the back

3. FIG. 1 white fibre sheet attached to the top of American flag classic; WALL FLAG with ‘GREATNESS’ written on it
